(19) United States
(12) Patent Application Publication
(10) Pub. No.: US 2005/0182860 A1
(43) Pub. Date: Aug. 18, 2005

(54) Method for operating a peripheral device on a bus system of a computer system

(75) Inventor: Christian Schneckenburger, Grasse (FR)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/062,317

(22) Filed: Feb. 18, 2005

(30) Foreign Application Priority Data
Feb. 18, 2004 (DE) 10 2004 007 994.3

(51) Int. Cl. G06F 3/00

(52) U.S. Cl. 710/8

(57) ABSTRACT

Method for operating a peripheral device on a bus system of a computer system, including the steps of providing for the computer system a bus driver, which has been extended by an authentication function, providing for the peripheral device a device driver, which has been extended by an authentication function, connecting the peripheral device to the bus system of the computer system, installing the device driver on the computer system, authenticating the peripheral device, and assigning a user an access right to the peripheral device connected to the computer system.

### CROSS-REFERENCE TO RELATED APPLICATION

This application claims priority to German Patent Application Serial No. 10 2004 007 994.3, which was filed on Feb. 18, 2004, and is incorporated herein by reference in its entirety.

### FIELD OF THE INVENTION

The present invention relates to a method for operating a peripheral device on a bus system of a computer system.

### BACKGROUND OF THE INVENTION

In addition to internal peripheral devices such as interface cards or hard disks, today's computer systems have a multiplicity of peripheral devices which can be externally operated, for example mobile data storage media which can be connected to a bus system of the computer system. Owing to their practicability and versatility, these data storage media are increasingly replacing storage media which can be integrated in the computer system.

The Universal Serial Bus (USB), in particular, is becoming increasingly important as a simple, universal standardized interface with a high level of scalability. One of the great advantages of the USB bus system is the ability to add or remove peripheral devices during operation. Connected devices are initialized on the bus system and the device driver is loaded.

If computer systems have sensitive data on their hard disks, a user will frequently remove storage media, for example floppy disk drives, from the computer system in order to prevent undesired data transfer of the sensitive data. Activating external peripheral devices on the computer system in the simplified manner described above, however, still makes it possible to interchange data. However, physically blocking the connection capability, for example blocking a physical connector in the computer system, prevents any interchange of data, with the result that even desired actions, for example installing software updates, can no longer be carried out.

### SUMMARY OF THE INVENTION

An object of the invention is thus to propose a solution that makes it possible to regulate the operation of peripheral devices on a computer system in an application-specific and/or device-specific manner.

This object is achieved by providing a method that comprises the steps of:
providing a bus driver, which has been extended by an authentication function, for the computer system,
providing a device driver, which has been extended by an authentication function, for the peripheral device,
connecting the peripheral device to the bus system of the computer system,
installing the device driver on the computer system,
authenticating the peripheral device, and
assigning a user access rights to the peripheral device connected to the computer system.

According to the invention, this controls a user's access to the peripheral device in a manner dependent on the assignment of access rights. The bus driver for the computer system and the device driver have been extended by an authentication function for the purpose of carrying out authentication. This function advantageously makes it possible for the peripheral device to be identified to the computer system, it being possible to use the identification to verify whether read and/or write access to the peripheral device can be implemented.

In order to implement authentication, the computer system sends a challenge (which is provided with data) to the peripheral device once it has identified the connected device and has installed the driver thereof that is needed to operate the device. A secure area of a memory in the peripheral device stores a key and a crypton algorithm. The peripheral device uses the algorithm and the key to calculate a response from the challenge data and transmits this response as response data to the computer system. The response data are then evaluated by the computer system.

This procedure has the advantage that manipulation of data to be transmitted is precluded to the greatest possible extent. The computer system can alternatively use a key that is identical to the peripheral device and an algorithm to itself encrypt the data which are transmitted to the peripheral device and can compare this result with the response data transmitted by the peripheral device or can compare data which have been created from various keys (assigned to peripheral devices) and are stored in a memory with the response data and can grant associated access rights on the basis of the comparison result.

In accordance with one preferred embodiment, the access rights are classified into read and/or write rights for a user of the peripheral device and into access denial. If, for example, the peripheral device is not able to identify itself to the computer system on account of a standard driver that has not implemented the authentication function, access to the peripheral device is fundamentally prevented.

If only read rights are granted, software stored on the peripheral device can be loaded into the computer system, for example. Read and write rights permit bidirectional data interchange between the peripheral device and the computer system.

The peripheral device may be in the form of a storage medium, for example a flash memory in the form of a memory stick. The method described above can be carried out for any desired peripheral devices which can be externally connected to any desired bus system of the computer system.

### BRIEF DESCRIPTION OF THE DRAWINGS

The invention will be explained in more detail below with reference to the figures which are illustrated in the drawings and in which:

FIG. 1 shows a diagrammatic illustration of components which are needed to carry out the method according to the invention; and

FIG. 2 shows a flowchart for explaining the method according to the invention.

### DETAILED DESCRIPTION OF PREFERRED EMBODIMENTS OF THE INVENTION

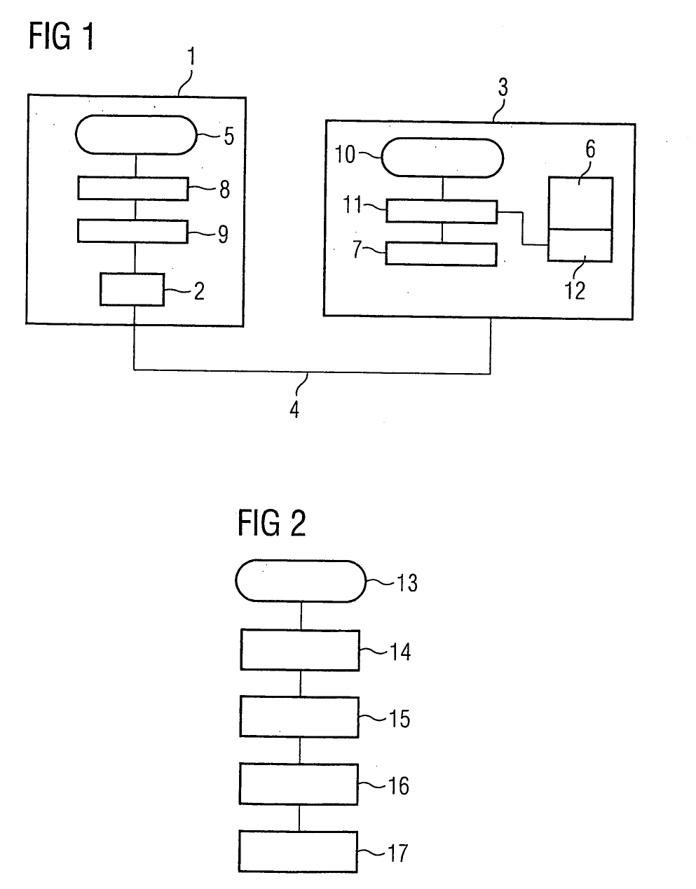

By way of example, FIG. 1 shows components for implementing the invention. A computer system 1, for example a conventional personal computer, has a bus system 2 for connecting an external peripheral device 3. In this case, both a serial bus system and a parallel bus system can be used. The peripheral device 3 is connected to the bus system 2 of the computer 1 via a connection 4. The computer 1 shown uses an operating system 5, for example from the Windows series of operating systems available from Microsoft.

Upon connection of the peripheral device 3, the operating system 5 of the computer 1 automatically checks an identifier stored in a memory 6 in the peripheral device 3 and automatically installs a device driver 7 that is available in the operating system 5 or in the peripheral device 3. The computer 1 furthermore has an authentication function 8 that first of all prevents the operating system 5 from enabling the connected peripheral device 3 and independently ascertains whether the peripheral device 3 is or is not enabled for a user. To this end, the authentication function 8 is connected as a logical interface between the bus system 2 or a bus driver 9 and the operating system 5.

The peripheral device 3 likewise has an authentication function 11 that is arranged logically between the device driver 7 and an operating system 10 of the peripheral device 3 and has the task of using a crypton algorithm and a key that is stored in a secure memory area 12 of the memory 6 to encrypt a data record that has been transmitted by the computer 1 and forwarding the data record to the computer 1. The computer 1 evaluates the received data record and uses an evaluation result to ascertain an access right for the user of the peripheral device 3.

FIG. 2 illustrates a method sequence according to the invention. Connecting the peripheral device 3 to the computer 1 causes the operating system 5 to check a device identifier for the peripheral device 3 in a first step 13. If the device identifier is known to the operating system 5, a device driver 7 that is available in the operating system 5 is installed. If the device 3 has not been registered, a manual setup box is used to request the user to install the software for the device 3 himself. The device is ready for operation after an address has been assigned.

The authentication function 8 enables access to the peripheral device 3. The authentication function 8 may be part of the bus driver 9. To this end, in a step 14, the authentication function 8 of the bus driver 9 transmits a data record to the peripheral device 3. The peripheral device 3 identifies and processes the request, on the basis of the authentication function that has been implemented and may likewise be part of the device driver, by using the key stored in the secure memory area 12 of the memory 6 to encrypt the data record and, in a step 15, transmitting a response as response data to the computer 1.

In a further step 16, the authentication function 8 of the bus driver 9 evaluates the response data and compares them with data which are stored in a memory of the computer system 1 and which refer to an access authorization to be assigned. The data can be configured such that an administrator of the computer can optionally determine which access rights to the peripheral devices provided with a defined key are to be granted to a user of the computer. The step of assigning the access rights is provided with reference numeral 17.

The method according to the invention makes it possible to manage access rights for peripheral devices—which are connected to a computer—in a very flexible and simplified manner. Various access rights can be assigned to different peripheral devices.

1. A method for operating a peripheral device on a bus system of a computer system, the method comprising the steps of:
providing a bus driver, which has been extended by an authentication function, for the computer system;
providing a device driver, which has been extended by an authentication function, for the peripheral device;
connecting the peripheral device to the bus system of the computer system;
installing the device driver on the computer system;
authenticating the peripheral device; and
assigning a user access rights to the peripheral device connected to the computer system.

2. The method as claimed in claim 1, wherein the authentication step comprises the steps of:
transmitting challenge data from the computer system to the peripheral device;
the peripheral device calculating authentication parameters using a crypton algorithm and secret key data;
transmitting the authentication parameters calculated by the peripheral device as response data to the computer system; and
the computer system processing the response data.

3. The method as claimed in claim 2, wherein the processing step comprises the steps of:
evaluating the response data; and
comparing the evaluation result with data which are stored in a memory in the computer system and which refer to access rights to be assigned.

4. The method as claimed in claim 1, wherein the step of assigning access rights comprises the step of assigning a read and/or write access right or no access rights.

5. The method as claimed in claim 3, wherein the authentication step is carried out by the authentication functions of the bus driver and device driver, respectively.

6. The method as claimed in claim 1, wherein, when assigning a read and/or write access right, the authentication functions of the bus driver make it possible for data to be interchanged between the computer system and the peripheral device in a manner dependent on the access rights.

7. The method as claimed in claim 2, further comprising the step of storing the secret key data in a secure memory area of a memory of the peripheral device.

8. The method as claimed in claim 1, wherein the access rights to the peripheral device are configured by the user of the computer system.

9. The method as claimed in claim 1, wherein the peripheral device is operated on a USB (Universal Serial Bus) or SCSI or FireWire bus system of the computer system.

10. The method as claimed in claim 1, wherein the peripheral device is a transportable storage medium, for example a flash memory.
